(19) United States
(12) Patent Application Publication
(10) Pub. No.: US 2024/0205891 A1
(43) Pub. Date: Jun. 20, 2024

(54) ENHANCED SEMI-PERSISTENT SCHEDULING (SPS) OPERATIONS

(71) Applicant: Nokia Technologies Oy, Espoo (FI)

(72) Inventors: Klaus Ingemann PEDERSEN, Aalborg (DK); Guillermo POCOVI, Aalborg (DK)

(21) Appl. No.: 18/553,567

(22) PCT Filed: Feb. 23, 2022
(86) PCT No.: PCT/EP2022/054514

§ 371 Date: Oct. 1, 2023

(30) Foreign Application Priority Data
Mar. 30, 2021 (US) 63167794

(51) Int. Cl. H04W 72/0446; H04L 5/00; H04W 72/23

(52) U.S. Cl. CPC H04W 72/0446; H04L 5/0044; H04W 72/23

(57) ABSTRACT

Systems, methods, apparatuses, and computer program products for enhanced semi-persistent scheduling (SPS) operations. Use of periodicities that may match extended reality (XR) may be provided. Various SPS resource allocation patterns that may not have equidistant times between allocations may also be provided. Additionally, or alternatively, an SPS configuration that may enable various options where an integer number of transport blocks may be sent per SPS cycle may be provided. This may include options where M transport blocks are sent per SPS cycle on time-consecutive resources, or on different component carriers if the UE is configured with carrier aggregation (CA). Configuration of a dynamic change of an SPS pattern may be provided.

### FIELD:

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to systems and/or methods for enhanced semi-persistent scheduling (SPS) operations.

### BACKGROUND:

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. 5G is mostly built on a new radio (NR), but a 5G (or NG) network can also build on E-UTRA radio. It is estimated that NR may provide bitrates on the order of 10-20 Gbit/s or higher, and may support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IOT). With IOT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) may be named gNB when built on NR radio and may be named NG-eNB when built on E-UTRA radio.

### SUMMARY:

According to a first embodiment, an apparatus may include at least one processor and at least one memory including computer program code. The at least one memory and the computer program code may be configured to, with the at least one processor, cause the apparatus at least to transmit, to a user equipment, a semi-persistent scheduling configuration including an indication of at least a number of transport blocks per semi-persistent scheduling cycle. The number of transport blocks may be more than one.

In a variant, the semi-persistent scheduling configuration may further include an indication of a periodicity or frequency of a semi-persistent scheduling cycle and a periodic time pattern indicating time instances where transport blocks associated with the semi-persistent scheduling configuration are scheduled. In a variant, the periodicity of the semi-persistent scheduling cycle may include a time interval between two resource allocations that is not constant. In a variant, the at least one memory and the computer program code may be configured to, with the at least one processor, further cause the apparatus at least to transmit, to the user equipment, a dynamic semi-persistent scheduling configuration for updating the semi-persistent scheduling configuration. In a variant, the dynamic semi-persistent scheduling configuration may include one or more updated parameters for the semi-persistent scheduling configuration.

In a variant, the one or more updated parameters may include at least one of one or more semi-persistent scheduling periodicities, one or more phases of one or more semi-persistent scheduling patterns, or one or more numbers of transport blocks per semi-persistent scheduling cycle. In a variant, one or more conditions for controlling application of the one or more updated parameters may include one or more of a change in signal quality conditions at the user equipment, a change in service after activation of the semi-persistent scheduling configuration, or a change in a size of a payload associated with the transport blocks after activation of the semi-persistent scheduling configuration. In a variant, the configuration may further include an indication that the transport blocks include contiguous resources in a time domain.

In a variant, the configuration may further include an indication that the transport blocks include non-contiguous resources in a time domain. In a variant, the configuration may further include an indication that the non-contiguous resources are separated by different time offsets or constant time offsets. In a variant, the configuration may include hybrid automatic repeat request process identifiers for the transport blocks. In a variant, the hybrid automatic repeat request process identifiers may be determined based on at least one or more of the number of transport blocks, a slot or symbol index of a first transport block in a current semi-persistent scheduling cycle, or a transport block of a semi-persistent scheduling cycle. In a variant, the semi-persistent scheduling configuration may further include an indication of at least whether multiple component carriers are to be used for the transport blocks.

According to a second embodiment, an apparatus may include at least one processor and at least one memory including computer program code. The at least one memory and the computer program code may be configured to, with the at least one processor, cause the apparatus at least to receive a semi-persistent scheduling configuration including an indication of at least a number of transport blocks per semi-persistent scheduling cycle. The number of transport blocks may be more than one.

In a variant, the semi-persistent scheduling configuration may further include an indication of a periodicity or frequency of a semi-persistent scheduling cycle and a periodic time pattern indicating time instances where transport blocks associated with the semi-persistent scheduling configuration are scheduled. In a variant, the periodicity of the semi-persistent scheduling cycle includes a time interval between two resource allocations that is not constant. In a variant, the at least one memory and the computer program code may be configured to, with the at least one processor, further cause the apparatus at least to receive a dynamic semi-persistent scheduling configuration for updating the semi-persistent scheduling configuration. The dynamic semi-persistent scheduling configuration may include one or more updated parameters for the semi-persistent scheduling configuration. In a variant, the one or more updated parameters may include at least a periodicity of the semi-persistent scheduling configuration. In a variant, the one or more updated parameters may include at least one of one or more semi-persistent scheduling periodicities, one or more phases of one or more semi-persistent scheduling patterns, or one or more numbers of transport blocks per semi-persistent scheduling cycle.

In a variant, the one or more conditions for controlling application of the one or more updated parameters may include one or more of a change in signal quality conditions at the apparatus, a change in service after activation of the semi-persistent scheduling configuration, or a change in a size of a payload associated with the transport blocks after activation of the semi-persistent scheduling configuration. In a variant, the configuration may further include an indication that the transport blocks include contiguous resources in a time domain. In a variant, the configuration may further include an indication that the transport blocks include non-contiguous resources in a time domain. In a variant, the configuration may further include an indication that the non-contiguous resources are separated by different time offsets or constant time offsets.

In a variant, the configuration may include hybrid automatic repeat request process identifiers for the transport blocks. In a variant, the hybrid automatic repeat request process identifiers may be determined based on at least one or more of the number of transport blocks, a slot or symbol index of a first transport block in a current semi-persistent scheduling cycle, and a transport block of a semi-persistent scheduling cycle. In a variant, the semi-persistent scheduling configuration may further include an indication of at least whether multiple component carriers are to be used for the transport blocks.

According to a third embodiment, a method may include transmitting, to a user equipment, a semi-persistent scheduling configuration including an indication of at least a number of transport blocks per semi-persistent scheduling cycle. The number of transport blocks may be more than one.

In a variant, the semi-persistent scheduling configuration may further include an indication of a periodicity or frequency of a semi-persistent scheduling cycle and a periodic time pattern indicating time instances where transport blocks associated with the semi-persistent scheduling configuration are scheduled. In a variant, the periodicity of the semi-persistent scheduling cycle may include a time interval between two resource allocations that is not constant. In a variant, the method may further include transmitting, to the user equipment, a dynamic semi-persistent scheduling configuration for updating the semi-persistent scheduling configuration. In a variant, the dynamic semi-persistent scheduling configuration may include one or more updated parameters for the semi-persistent scheduling configuration. In a variant, the one or more updated parameters may include at least one of one or more semi-persistent scheduling periodicities, one or more phases of one or more semi-persistent scheduling patterns, or one or more numbers of transport blocks per semi-persistent scheduling cycle. In a variant, one or more conditions for controlling application of the one or more updated parameters may include one or more of a change in signal quality conditions at the user equipment, a change in service after activation of the semi-persistent scheduling configuration, or a change in a size of a payload associated with the transport blocks after activation of the semi-persistent scheduling configuration.

In a variant, the configuration may further include an indication that the transport blocks include contiguous resources in a time domain. In a variant, the configuration may further include an indication that the transport blocks include non-contiguous resources in a time domain. In a variant, the configuration may further include an indication that the non-contiguous resources are separated by different time offsets or constant time offsets. In a variant, the configuration may include hybrid automatic repeat request process identifiers for the transport blocks. In a variant, he hybrid automatic repeat request process identifiers may be determined based on at least one or more of the number of transport blocks, a slot or symbol index of a first transport block in a current semi-persistent scheduling cycle, or a transport block of a semi-persistent scheduling cycle. In a variant, the semi-persistent scheduling configuration may further include an indication of at least whether multiple component carriers are to be used for the transport blocks.

According to a fourth embodiment, a method may include receiving a semi-persistent scheduling configuration including an indication of at least a number of transport blocks per semi-persistent scheduling cycle. The number of transport blocks may be more than one.

In a variant, the semi-persistent scheduling configuration may further include an indication of a periodicity or frequency of a semi-persistent scheduling cycle and a periodic time pattern indicating time instances where transport blocks associated with the semi-persistent scheduling configuration are scheduled. In a variant, the periodicity of the semi-persistent scheduling cycle may include a time interval between two resource allocations that is not constant. In a variant, the method may further include receiving a dynamic semi-persistent scheduling configuration for updating the semi-persistent scheduling configuration. In a variant, the dynamic semi-persistent scheduling configuration may include one or more updated parameters for the semi-persistent scheduling configuration. In a variant, the one or more updated parameters may include at least a periodicity of the semi-persistent scheduling configuration. In a variant, the one or more updated parameters may include at least one of: one or more semi-persistent scheduling periodicitics, one or more phases of one or more semi-persistent scheduling patterns, or one or more numbers of transport blocks per semi-persistent scheduling cycle. In a variant, the one or more conditions for controlling application of the one or more updated parameters may include one or more of a change in signal quality conditions at an apparatus, a change in service after activation of the semi-persistent scheduling configuration, or a change in a size of a payload associated with the transport blocks after activation of the semi-persistent scheduling configuration.

In a variant, the configuration may further include an indication that the transport blocks include contiguous resources in a time domain. In a variant, the configuration may further include an indication that the transport blocks comprise non-contiguous resources in a time domain. In a variant, the configuration may further include an indication that the non-contiguous resources are separated by different time offsets or constant time offsets. In a variant, the configuration may include hybrid automatic repeat request process identifiers for the transport blocks. In a variant, he hybrid automatic repeat request process identifiers may be determined based on at least one or more of the number of transport blocks, a slot or symbol index of a first transport block in a current semi-persistent scheduling cycle, and a transport block of a semi-persistent scheduling cycle. In a variant, the semi-persistent scheduling configuration may further include an indication of at least whether multiple component carriers are to be used for the transport blocks.

A fifth embodiment may be directed to an apparatus that may include circuitry configured to cause the apparatus to perform the method according to the third embodiment or the fourth embodiment, or any of the variants of those embodiments discussed above.

A sixth embodiment may be directed to an apparatus that may include means for performing the method according to the third embodiment or the fourth embodiment, or any of the variants of those embodiments discussed above. Examples of the means may include one or more processors, memory, and/or computer program codes for causing the performance of the operation.

A seventh embodiment may be directed to a computer readable medium comprising program instructions stored thereon for causing an apparatus to perform at least the method according to the third embodiment or the fourth embodiment, or any of the variants of those embodiments discussed above.

An eighth embodiment may be directed to a computer program product encoding instructions for causing an apparatus to perform at least the method according to the third embodiment or the fourth embodiment, or any of the variants of those embodiments discussed above.

According to an example embodiment, there is provided an apparatus, comprising: at least one processor: and at least one memory including computer program code, wherein the at least one memory and the computer program code are configured to, with the at least one processor, cause the apparatus at least to: transmit, to a user equipment, a semi-persistent scheduling configuration comprising an indication. According to an embodiment, the user equipment is configured to receive the semi-persistent scheduling configuration comprising the indication.

According to an example embodiment, the indication indicates a number of transport blocks per semi-persistent scheduling cycle, wherein the number of transport blocks is more than one.

According to another example embodiment, the indication alternatively or additionally to indicating the number of transport blocks indicates a periodicity or frequency of a semi-persistent scheduling cycle. In an embodiment, the periodicity or frequency of the semi-persistent scheduling cycle is non-integer. In an embodiment, the indication further indicates a periodic time pattern indicating time instances where transport blocks associated with the semi-persistent scheduling configuration are scheduled.

According to an example embodiment, there is provided an apparatus, comprising: at least one processor: and at least one memory including computer program code, wherein the at least one memory and the computer program code are configured to, with the at least one processor, cause the apparatus at least to: transmit, to a user equipment, a dynamic semi-persistent scheduling configuration for updating a semi-persistent scheduling configuration, wherein the dynamic semi-persistent scheduling configuration comprises one or more updated parameters for the semi-persistent scheduling configuration. According to an embodiment, the user equipment is configured to receive the dynamic semi-persistent scheduling configuration.

In an example embodiment, the one or more updated parameters comprise an indication of a number of transport blocks and/or indication of non-integer periodicity or frequency. In an embodiment, the number of transport blocks is more than one.

### BRIEF DESCRIPTION OF THE DRAWINGS:

For proper understanding of example embodiments, reference should be made to the accompanying drawings, wherein:

FIG. 1 illustrates an example signal diagram for signaling for enhanced SPS operations, according to some embodiments:

FIG. 2 illustrates an example of an SPS configuration for contiguous resource allocations for transport blocks (TBs) of SPS bursts, according to some embodiments:

FIG. 3 illustrates an example of an SPS configuration for non-contiguous resource allocations for TBs for SPS bursts, according to some embodiments:

FIG. 4 illustrates an example of an identifier numbering scheme for an SPS configuration with multiple TBs per SPS burst, according to some embodiments:

FIG. 5 illustrates an example of an SPS configuration where resources are on different component carriers (CCs) for transmission of separate TBs, according to some embodiments:

FIG. 6 illustrates an example of dynamic change of an SPS periodicity via an SPS configuration, according to some embodiments:

FIG. 7 illustrates an example of a dynamic change of an SPS phase while maintaining an SPS periodicity, according to some embodiments:

FIG. 8 illustrates an example flow diagram of a method, according to some embodiments:

FIG. 9 illustrates an example flow diagram of a method, according to some embodiments:

FIG. 10a illustrates an example block diagram of an apparatus, according to an embodiment: and

FIG. 10b illustrates an example block diagram of an apparatus, according to another embodiment.

### DETAILED DESCRIPTION:

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for enhanced SPS operations is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments. In addition, the phrase “set of” refers to a set that includes one or more of the referenced set members. As such, the phrases “set of,” “one or more of,” and “at least one of,” or equivalent phrases, may be used interchangeably. Further, “or” is intended to mean “and/or,” unless explicitly stated otherwise.

Additionally, if desired, the different functions or operations discussed below may be performed in a different order and/or concurrently with each other. Furthermore, if desired, one or more of the described functions or operations may be optional or may be combined. As such, the following description should be considered as merely illustrative of the principles and teachings of certain example embodiments, and not in limitation thereof.

NR may provide support for extended reality (XR) scenarios. XR services may include cloud gaming (CG), virtual reality (VR), and augmented reality (AR) scenarios. These types of services may consume high data rates and may be bounded by latency conditions to satisfy the end-user quality of experience (QoE). As an example, CG may need to have, e.g., 30 megabits per second

(Mbps) (full high definition (FHD) resolution) to 45 Mbps (4K resolution) with latency bounds of, e.g., 15 milliseconds (ms). AR and/or VR services may be more demanding with tighter delay bounds of, e.g., 10 ms. The XR data may arrive as frame bursts at, e.g., 60 frames per second (fps), 90 fps, or 120 fps. For some XR applications with advanced adaptive video encoding, the fps rate may be adjusted dynamically. If the average source data rate equals, e.g., 45 Mbps with 60 fps, the average payload size per frame may equal, e.g., 750 kilobits (kbits) (or equivalently 94 kilobytes (kBytes)). This is a large payload to be reliably delivered with the bounded latency of, e.g., 10 ms or 15 ms (depending on the XR scenario).

Several downlink (DL) SPS enhancements are included in NR, such as to support URLLC and time-sensitive communication (TSC). SPS may reduce the overhead compared to sending DL dynamic scheduling grants (e.g., reduced physical downlink control channel (PDCCH) overhead). In addition to the lower PDCCH overhead, use of SPS may also help to offload the computational burden from a busy dynamic gNB scheduler. DL SPS has various characteristics, including the following: 1) DL radio resources for sending one TB with a regular time-periodicity may be configured for a UE: 2) up to 8 simultaneous active SPS configurations can be configured for a UE (e.g., configured through radio resource control (RRC) signaling): 3) a periodicity of any integer of a slot (N*14), where the minimum periodicity in may be, e.g., 10 ms: 4) separate configuration (RRC-based) and activation or deactivation (e.g., PDCCH addressed to a configured scheduling radio network temporary identifier (CS-RNTI) can either signal and activate the configured downlink assignment, or deactivate it): 5) joint release of multiple SPS configurations (RRC-based); 6) overlapping in time of 2 or more SPS physical downlink shared channel (PDSCH) transmissions (e.g., the UE may decode the transmission with the lowest SPS configuration index); and 7) hybrid automatic repeat request acknowledgement (HARQ-ACK) feedback for multiple configurations using both Type-1 and Type-2 HARQ-ACK codebooks.

Given the deterministic behavior of XR traffic, it may be desirable to be able to use SPS for DL scheduling of such traffic. In order to support SPS for XR scenarios, various problems in NR may be solved. As a first example problem, a current configuration of the SPS periodicity (fixed and constant) is limited to any integer of a radio slot (N*14 symbols). This means that it may not be possible to configure SPS patterns with periodicities that match 60 fps, 90 fps, and 120 fps. Moreover, SPS may have to support configurations with clements of non-periodical patterns. As a second example problem. NR SPS has to support sending more than one transport block every N slots (e.g., SPS periodicity per configuration). For example, for XR use cases with large payload sizes per frame (e.g., 94 kBytes as in the example mentioned above), it may have to be possible to fit the full payload or frame into a single transport block. It may, therefore, be desirable to have SPS options where an integer number of TBs can be sent per SPS cycle. As a third example problem, NR SPS has to support XR use cases with adaptive video encoding where the number of fps is occasionally modified. For example, if the SPS pattern, e.g., is configured (by RRC) for one particular fps setting, then the SPS configuration may have to be released, and a new SPS configuration (e.g., with a periodicity matching the new fps) may have to be configured (and activated) if the number of fps changes. This may involve multiple downlink control information (DCI) transmission and RRC messages, and may be slow, error-prone, and may be an inflexible process. As can be understood from the above, there may be a need for enhanced SPS operations.

Some embodiments described herein may provide for enhanced SPS operations. For example, certain embodiments may provide for use of periodicities that may match XR scenarios (e.g., CG, VR, and/or AR scenarios) fps rates of, e.g., 60, 90, and 120 fps. Continuing with this example, certain embodiments may provide for various SPS resource allocation patterns that may not have equidistant times between allocations. Additionally, or alternatively, and as another example, certain embodiments may provide for an SPS configuration that may enable various options where an integer number of transport blocks may be sent per SPS cycle. This may include options where M transport blocks are sent per SPS cycle on time-consecutive resources, or on different component carriers if the UE is configured with carrier aggregation (CA). Configuration of the previous two examples may occur via an information element in, e.g., RRC signalling (e.g., via a SPS-ConfigIndex message). As another example. certain embodiments may provide for configuration of a dynamic change of an SPS pattern to. e.g., facilitate adaptation to varying payload or fps rate changes for XR services, without having to release and configure a new SPS pattern. This option may be configured via RRC or a medium access control control element (MAC-CE), via PHY-layer signalling, and/or the like. In this way, certain embodiments may conserve network resources (e.g., bandwidth) and/or computing resources of devices associated with use of SPS by solving at least one or more of the problems described above.

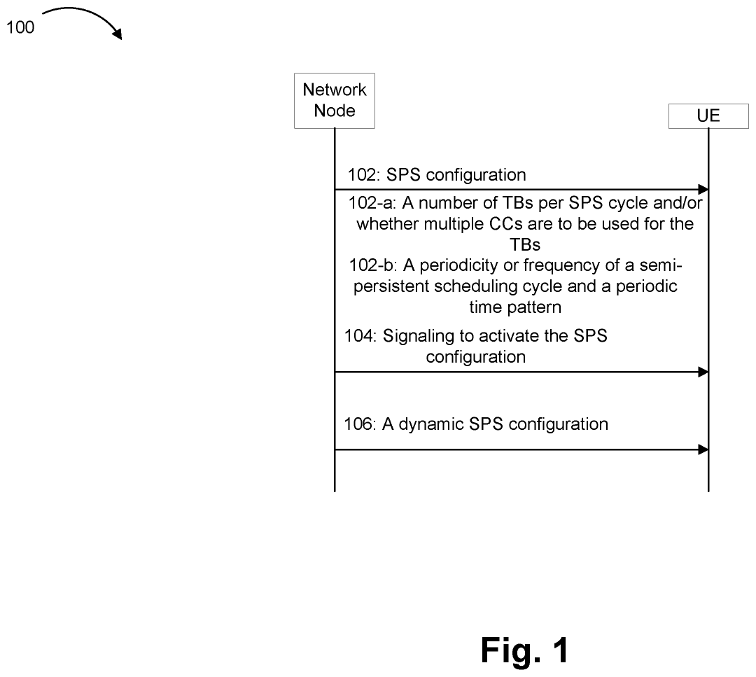

FIG. 1 illustrates an example signal diagram 100 for enhanced SPS operations, according to some embodiments. As illustrated in FIG. 1, the example signal diagram 100 includes a network node (e.g., a gNB) and a UE.

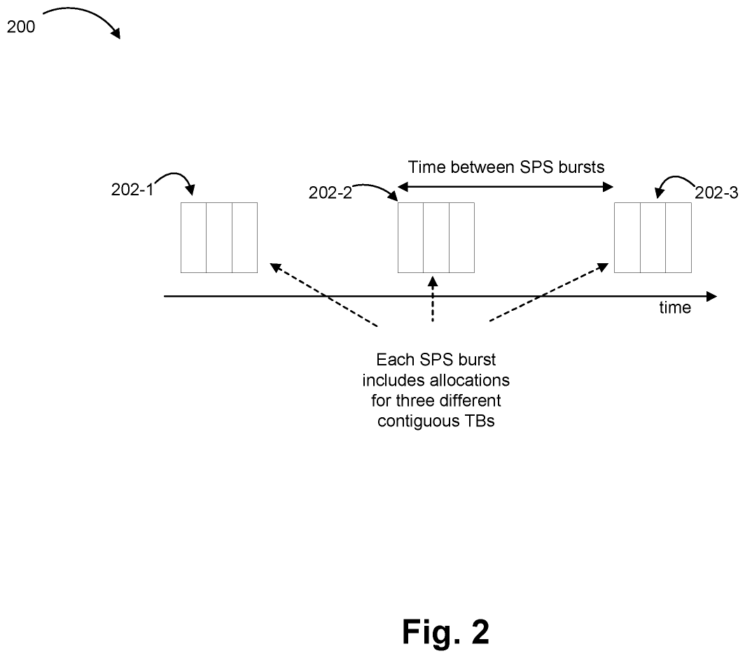

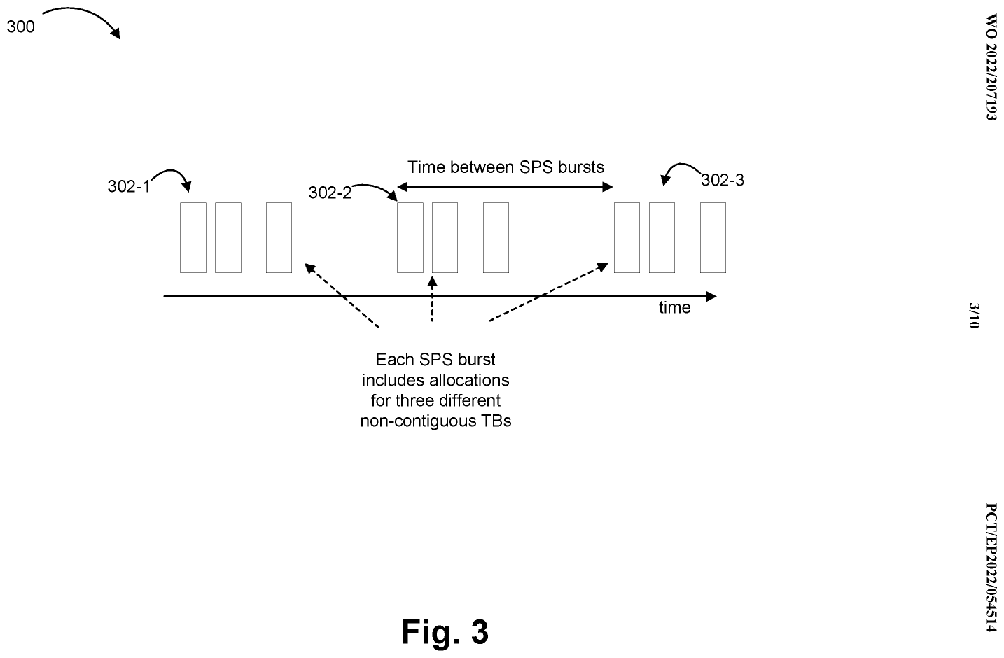

As illustrated at 102, the network node may transmit, and the UE may receive, an SPS configuration. As illustrated at 102-a, the SPS configuration may include an indication of a number of TBs per SPS cycle. Additionally, or alternatively, the SPS configuration at 102-a may include an indication of whether multiple CCs are to be used for the TBs. For example, SPS configurations described herein may use multiple CCs if the UE is configured to use CA. Additionally, or alternatively, and as illustrated at 102-b, the SPS configuration may include an indication of a periodicity or frequency of a semi-persistent scheduling cycle and a periodic time pattern indicating time instances where transport blocks associated with the semi-persistent scheduling configuration are scheduled. For example, the periodicities may be indicated using non-integer values of radio symbols, slots, or subframes, e.g., 120 Hz corresponding to 8.3333 ms. For example, periodicity of SPS may support non-integer values. Such values may match fps rates of e.g. 60, 90, or 120. Such non-integer periodicity may be indicated in the SPS configuration, for example. The TBs may include contiguous resources in a time domain. For example, each SPS burst may include TBs that are transmitted without a time offset between the end of one TB and the start of the next TB (e.g., as described in the context of FIG. 2 elsewhere herein). Alternatively, the TBs may include non-contiguous resources. For example, each SPS burst may include TBs that are transmitted with a time offset between the end of one TB and the start of the next TB (e.g., as described in the context of FIG. 3 elsewhere herein). The non-contiguous resources may be separated by different time offsets or constant time offsets. According to an example, the SPS configuration is for XR services.

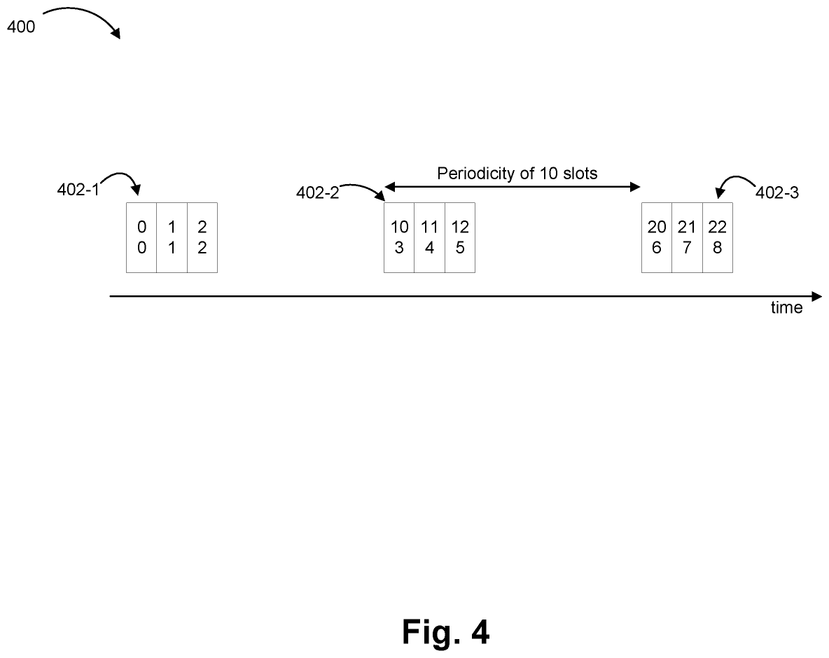

The configuration may include identifiers for the TBs (e.g., as described with respect to FIG. 4 elsewhere herein). For example, the identifiers may be HARQ process identifiers. The identifiers may be determined based on the number of TBs, a slot index of a first TB in a current SPS cycle, a TB of a SPS cycle, and/or one or more other parameters, as described elsewhere herein. In certain embodiments, the signaling illustrated at 102 may include RRC signaling. For example, the configurations may be included in IEs included in the RRC signaling (e.g., in a SPS-ConfigIndex message).

As illustrated at 104, the network node may transmit, and the UE may receive, signaling to activate the SPS configuration. For example, the signaling at 104 may cause the UE to operate according to the SPS configuration (e.g., according to the number of TBs per cycle, whether multiple CCs are to be used for the TBs, integer values to be used for the periodicity of the SPS, etc.). As illustrated at 106, the network node may transmit, and the UE may receive, a dynamic SPS configuration. For example, the SPS configuration may include one or more parameters to be applied based on satisfaction of one or more conditions to dynamically change the SPS configuration without additional signaling from the network node to re-configure the UE. The one or more parameters may include one or more SPS periodicities, one or more phases of one or more SPS patterns, one or more numbers of TBs per SPS cycle, and/or the like. The one or more conditions may include a change in service after activation of the SPS configuration, a change in a size of a payload associated with the TBs after activation of the SPS configuration, a change of the signal quality conditions experienced by the UE, and/or the like. The dynamic SPS configuration may be included in a MAC-CE signaling. RRC signaling, and/or the like.

As described above, FIG. 1 illustrates certain operations and signaling of the SPS scheme according to certain embodiments. In this way, certain embodiments may configure multiple TBs per SPS burst, various patterns of periodicities, etc., and may configure use of multiple CCs. Additionally, or alternatively, in this way, the SPS configuration may be activated, after the SPS has been configured. After some time, the network node may choose to dynamically alter the existing SPS configuration (e.g., the SPS periodicity, phase of the SPS pattern, number of TBs per SPS bursts, etc.). Thus, certain embodiments described herein may provide for a less error-prone and more effective change of an SPS configuration compared to having to release a current SPS configuration, followed by reconfiguration and activation of the configuration. This conserves radio resources and computing resources of the network node and/or the UE by reducing the amount of configuration-related signaling needed to implement a new configuration at the UE.

As described above, FIG. 1 is provided as an example. Other examples are possible, according to some embodiments.

FIGS. 2, 3, and 4 may illustrate examples where the SPS configuration may include allocation of resources for transmission of multiple TBs for each SPS burst, according to certain embodiments. FIGS. 2 and 3 illustrate examples where the SPS configuration includes transmission of three different TBs per SPS burst. In the example of FIG. 2, the transmission resources for the three TBs are illustrated as contiguous resources in the time-domain. In the example of FIG. 3, the transmission resources for the three TBs per SPS burst are non-contiguous in the time-domain. The non-contiguous scenario may include different or constant time offsets between the resources for the three TBs. Although the examples in FIGS. 2 and 3 are for transmission of three different TBs per SPS burst, other options with other configurations of resources for transmission of any integer number of TBs may also be provided according to some embodiments. The SPS configuration with resources for transmission of multiple TBs per SPS burst may be useful for, e.g., XR applications with large payloads that cannot be delivered in a single transmission time interval (TTI). This may be the case for NR frequency range 1 (FRI) deployments, where the carrier bandwidth may be limited, e.g., on the range of 20-100 megahertz (MHz) if using 15 kilohertz (kHz) or 30 kHz subcarrier spacing (SCS).

FIG. 2 illustrates an example 200 of an SPS configuration for contiguous resource allocations for TBs of SPS bursts, according to some embodiments. As illustrated in FIG. 2, the example 200 includes SPS bursts 202-1, 202-2, and 202-3. As further illustrated in FIG. 2, cach SPS burst 202 may include resource allocations for three different contiguous TBs (where cach TB is represented by a white rectangle). The contiguous TBs of an SPS burst may be configured such that there is no time offset between the end of one TB and the start of the next TB.

As indicated above, FIG. 2 is provided as an example. Other examples are possible, according to some embodiments.

FIG. 3 illustrates an example 300 of an SPS configuration for non-contiguous resource allocations for TBs for SPS bursts, according to some embodiments. As illustrated in FIG. 3, the example 300 may include SPS burst 302-1, 302-2, and 302-3. As further illustrated in FIG. 3, cach SPS burst 302 may include resource allocations for three different non-contiguous TBs (where cach TB is represented by a white rectangle). The non-contiguous TBs may be configured such that there is a time offset between the end of one TB and the start of the next TB. As further illustrated in FIG. 3, the offsets between the first two TBs in cach SPS burst 302 may be a constant time offset, but within cach SPS burst 302, the first two TBs and the second two TBs are separated by different time offsets. In this way, the non-contiguous resources may be separated by different time offsets or constant time offsets.

As described above, FIG. 3 is provided as an example. Other examples are possible, according to some embodiments.

To implement the embodiments illustrated in, and described with respect to, FIGS. 2 and 3, the UE may be informed of the number of TBs per SPS burst, as well the time-offsets between the TBs in the SPS burst via DCI, RRC configuration, and/or the like. For contiguous TBs as in FIG. 2, certain embodiments may signal to the UE the number of TBs per SPS burst, e.g., included in the SPS-Config IE in the RRC message, or in the DCI activating the SPS configuration (e.g., via a 2 bit field indicating a value in the range of, e.g., [1, 4]). For the case of non-contiguous TBs in FIG. 3, the time-offsets may be indicated in the SPS-Config IE, e.g., as a sequence of integer[x, y, z, . . . ] where x may indicate the offset between the first and second TB (in symbols, slots, or any other predefined or configurable resolution), y may indicate the offset between the second and a third TB, etc. Some joint DCI-RRC signaling may also be possible, where, e.g., 2 bits in the DCI may be used to dynamically indicate one of multiple possible combinations of time-offsets and/or number of TBs. Regarding other parameters of the TB, such as time-domain duration, frequency-domain resources, modulation and carrier scheme (MCS), etc., these parameters may be the same for each of the TBs in the SPS burst. For example, the parameters may be based on information is indicated in the DCI (re-)activating the SPS configuration.

A HARQ process identifier may be determined for each of the SPS TBs of the SPS configuration. For example, the HARQ process identifier may be determined in such a way that consecutive TBs may not be associated with the same HARQ process identifier. For example, the HARQ process identifier may be determined according to the following equation:

$$HARQ Process ID = [ N * floor ( CURRENT\_slot \_of \_first \_TB \_in \_Burst \times 10 \text{} / ( numberOfSlotsPerFrame \times periodicity ) ) + TB\_n - 1 ] modulo nrofHARQ - Processes + harq - ProcID - Offset$$

where N may represent the total number of TBs in each SPS burst (e.g., 3 in the examples in FIGS. 2 and 3), and TB_n may represent the actual TB of the burst (e.g., increasing sequentially from 1 to N for each burst). FIG. 4 illustrates an example of the resulting HARQ process identifiers with the above equation, assuming N=3, a periodicity (periodicity) of 10 slots, a HARQ process identifier offset (harq-ProcII)-Offset) equal to 0, and number of HARQ processes (nrofHARQ)-Processes) greater than 8. CURRENT_slot_of_first_TB_in_Burst may represent the slot index of the first TB in the current SPS burst, e.g., 0, 10, and 20 in the example in FIG. 4. numberOfSlotsPerFrame may represent the number of slots that are included in each frame.

FIG. 4 illustrates an example 400 of an identifier numbering scheme for an SPS configuration with multiple TBs per SPS burst, according to some embodiments. As illustrated in FIG. 4, the example 400 may include three SPS bursts 402-1, 402-2, and 402-3. The start of the SPS burst 402-2 and the start of the SPS burst 402-3 may be separated by a configured periodicity of, e.g., 10 slots. The TBs of the SPS burst 402-1 may have index values of 0, 1, and 2, and HARQ process identifiers of 0, 1, and 2, respectively. The TBs of the SPS burst 402-2 may have index values of 3, 4, and 5, and identifiers of 10, 11, and 12, respectively. The TBs of the SPS burst 402-3 may have index values of 6, 7, and 8, and may have identifiers of 20, 21, and 22, respectively.

As described above, FIG. 4 is provided as an example. Other examples are possible, according to some embodiments.

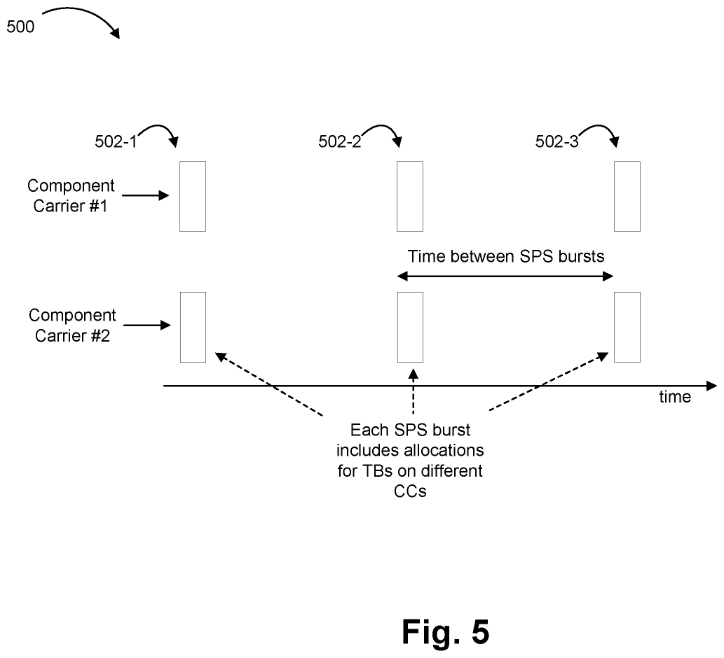

FIG. 5 illustrates an example 500 of an SPS configuration where resources are on different component carriers (CCs) for transmission of separate TBs, according to some embodiments. As illustrated in FIG. 5, there may be three SPS bursts 502-1, 502-2, and 502-3. Each of the SPS bursts 502 may include two TBs on different component carriers (component carrier #1 and component carrier #2). In this way, each SPS burst may comprise resource allocations for TBs on different CCs.

As described above, FIG. 5 is provided as an example. Other examples are possible, according to some embodiments.

As described above, FIG. 5 illustrates an example for a UE that is configured with CA between CC #1 and CC #2. The scenario in FIG. 5 may apply, e.g., to UEs that may be configured with CA of two CCs of 100 MHz in the 3.5 GHz band, UEs operating with CA between 800 MHZ and 2.1 GHz bands, or for UEs with CA between FRI and frequency range 2 (FR2) bands. CA cases for XR applications may be considered relevant due to the high data rate demands and bounded latency conditions for such cases. The SPS configuration for CA cases may be advantageous as it may allow for jointly configuring SPS resources on multiple CCs at a time, as compared to having to separately configure (and activate) an SPS pattern per CC. The embodiments illustrated in FIG. 5 may be easier to implement for the case where the involved CCs are in the same band (e.g., the ˜3.5 GHz band), using the same SCS, and identical physical resource block (PRB) allocation and MCS for the two CCs. For such scenarios, enhanced RRC signalling for the SPS configuration may be realized by determining similar parameters for the two CCs. The IE in the SPS-ConfigIndex message described above may indicate for which CCs the configurations are valid. Similarly, the DCI expressing the number of PRBs and MCS for the SPS transmission may be applicable for both. However, if the CCs are different (e.g., a different quality, different SCS, different bandwidth, etc.), the DCI for indicating the PRBs and MCS for the illustrated SPS scenario in FIG. 5 may be indicated in two separate DCIs for the CCs.

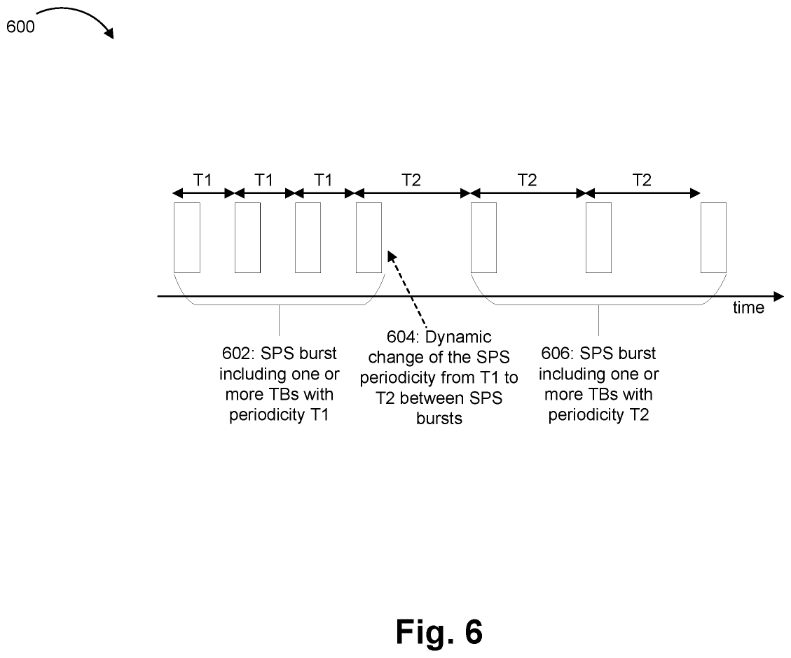

FIG. 6 illustrates an example 600 of dynamic change of an SPS periodicity via an SPS configuration, according to some embodiments. As illustrated at 602, an SPS burst may include one or more TBs with periodicity T1. As illustrated at 604, the UE may implement a dynamic change of the SPS periodicity from T1 to T2 between SPS bursts. As illustrated at 606, the SPS burst may include, after the dynamic change, one or more TBs with periodicity T2, where T2 is different than T1.

As described above, FIG. 6 is provided as an example. Other examples are possible, according to some embodiments.

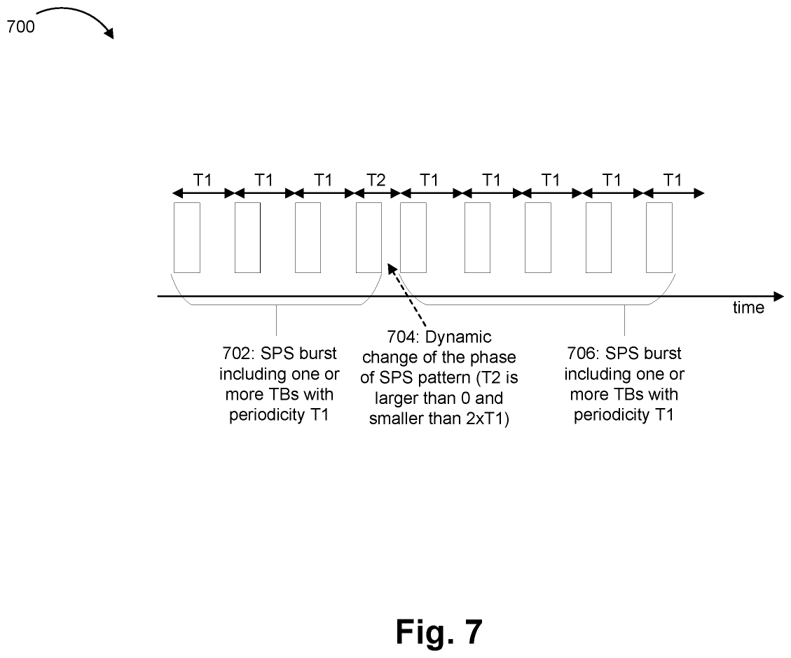

FIG. 7 illustrates an example 700 of a dynamic change of an SPS phase while maintaining an SPS periodicity, according to some embodiments. As illustrated at 702, an SPS burst may include one or more TBs with periodicity T1. As illustrated at 704, the UE may implement a dynamic change of the phase of the SPS pattern (e.g., from T1 to T2). In the example 700, T1 may be larger than 0 and smaller than twice the value of T1. As illustrated at 706, the SPS burst may include one or more TBs with periodicity T1.

As described above, FIG. 7 is provided as an example. Other examples are possible, according to some embodiments.

As illustrated in FIGS. 6 and 7, the SPS may be dynamically reconfigured. FIG. 6 may illustrate a manner in which the periodicity (e.g., the time between SPS bursts) is dynamically changed from T1 to T2 between SPS bursts. The dynamic change may be configured via RRC or MAC-CE signalling. The signalling for the dynamic change for the SPS periodicity may include explicit information expressing at which time (e.g., expressed in terms of system frame number (SFN), or SFN plus number of slots) the SPS periodicity may be implemented. This functionality may be, e.g., considered useful for various XR applications with adaptive (semi-adaptive encoding schemes where the XR source data pattern may be occasionally changed, and certain embodiments may also modify the corresponding SPS pattern. Certain embodiments may reduce or eliminate the need to fully release the existing SPS configuration, followed by configuring (and activating) a new SPS pattern, which may conserve network and/or computing resources. The example in FIG. 7 may illustrate a similar example where the phase of the SPS pattern may be adjusted dynamically, while maintaining the same periodicity of the pattern. The dynamic change of an existing SPS pattern may also include a change of the number of TBs per SPS (e.g., which may be useful if the source data rate of the XR stream is altered due to switching to a higher or lower video resolution).

As discussed elsewhere herein, certain embodiments may provide for configuration of SPS periodicity to better match the packet and/or frame arrival patterns of, e.g., XR data flows. Certain embodiments described herein may reduce or eliminate the need for strictly periodic SPS resource allocation patterns with a constant number integer slots or symbols between the SPS burst. For example, certain embodiments may provide for an SPS pattern that is more flexible and may be expressed as an arbitrary pattern that is repeated every N 10 ms radio frame(s), where N may be an integer subject to the following condition: N∈[1,2,3 . . . ]. Within those N 10 ms radio frames, the time-domain SPS resource pattern may be expressed with a vector of binary elements having a length of M, where M may equal a number of slots within the N 10 ms radio frames. For 15 kHz SCS M=N×10. for 30 kHz M=N×10×2, for 60 kHz M=N×10×4, etc. When an element in the vector is set to one, the vector may indicate to apply an SPS resource allocation, while a vector set to zero may indicate no SPS resource allocation. The value of N and the SPS resource allocation vector may be included as IEs in the RRC: SPS-ConfigIndex message.

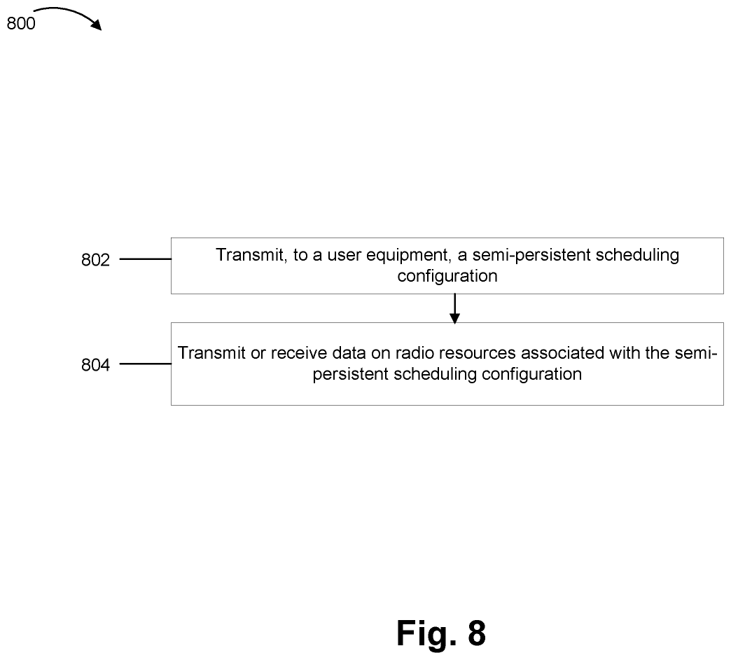

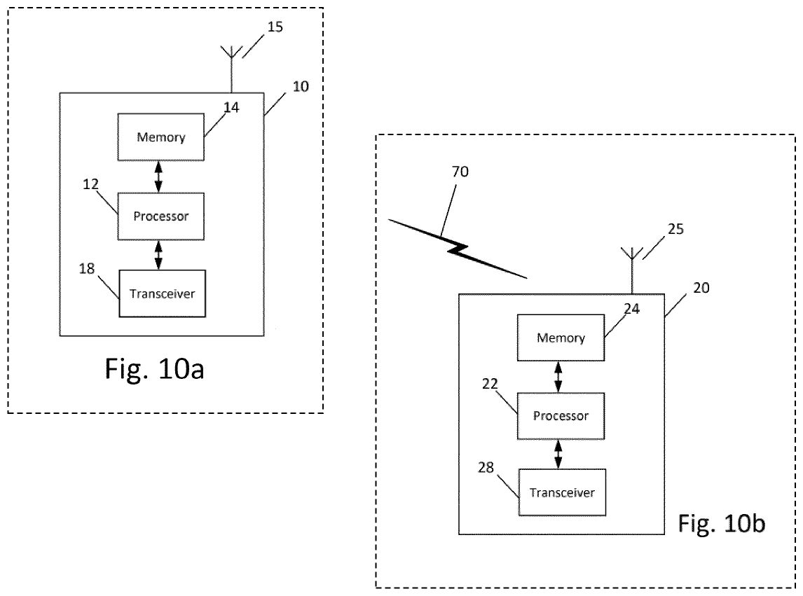

FIG. 8 illustrates an example flow diagram of a method 800, according to some embodiments. For example, FIG. 8 may illustrate example operations of a network node (e.g., apparatus 10 illustrated in, and described with respect to, FIG. 10a). Some of the operations illustrated in FIG. 8 may be similar to some operations shown in, and described with respect to, FIGS. 1-7.

In an embodiment, the method 800 may include, at 802, transmitting, to a user equipment, a semi-persistent scheduling configuration, e.g., in a manner similar to that at 102 of FIG. 1. The semi-persistent scheduling may include an indication of at least: a number of transport blocks per semi-persistent scheduling cycle, e.g., in a manner similar to that at 102-a of FIG. 1. The number of transport blocks may be more than one. The method 800 may include, at 804. transmitting or receiving data on radio resources associated with the semi-persistent scheduling configuration.

The method illustrated in FIG. 8 may include one or more additional aspects described below or elsewhere herein. In some embodiments, the method 800 may include transmitting, to the user equipment, signaling to activate the semi-persistent scheduling configuration, e.g., in a manner similar to that at 104 of FIG. 1. In some embodiments, the semi-persistent scheduling configuration may further include an indication of a periodicity or frequency of a semi-persistent scheduling cycle and a periodic time pattern indicating time instances where transport blocks associated with the semi-persistent scheduling configuration are scheduled. In some embodiments, the periodicity of the semi-persistent scheduling cycle may include a time interval between two resource allocations that is not constant. In some embodiments, the method 800 may further include transmitting, to the user equipment, a dynamic semi-persistent scheduling configuration for updating the semi-persistent scheduling configuration, e.g., in a manner similar to that at 106 of FIG. 1. The dynamic semi-persistent scheduling configuration may be transmitted separately from the operations illustrated in FIG. 8. In some embodiments, the dynamic semi-persistent scheduling configuration may include one or more updated parameters for the semi-persistent scheduling configuration. In some embodiments, the one or more updated parameters may include at least one of: one or more semi-persistent scheduling periodicities, one or more phases of one or more semi-persistent scheduling patterns, or one or more numbers of transport blocks per semi-persistent scheduling cycle. In some embodiments, the one or more conditions may include one or more of: a change in signal quality conditions at the user equipment, a change in service after activation of the semi-persistent scheduling configuration, or a change in a size of a payload associated with the transport blocks after activation of the semi-persistent scheduling configuration.

In some embodiments, the configuration may further include an indication that the transport blocks may include contiguous resources in a time domain. In some embodiments, the configuration may further include an indication that the transport blocks may include non-contiguous resources in a time domain. In some embodiments, the configuration may further include an indication that the non-contiguous resources may be separated by different time offsets or constant time offsets. In some embodiments, the configuration may include hybrid automatic repeat request process identifiers for the transport blocks. In some embodiments, the identifiers may be determined based on at least one or more of: the number of transport blocks, a slot or symbol index of a first transport block in a current semi-persistent scheduling cycle, or a transport block of a semi-persistent scheduling cycle. In some embodiments, the semi-persistent scheduling configuration may further include an indication of at least whether multiple component carriers are to be used for the transport blocks. So, for example, the semi-persistent scheduling configuration may configure UE to utilize more than one component carriers. Component carrier herein may sometimes be referred to simply as carrier or CC. It is further noted that if multiple carriers are used, different transport blocks of the same semi-persistent scheduling configuration may be transmitted on different carriers. Thus, for example, a first transport block of the same semi-persistent scheduling configuration may be transferred on first carrier and second transport block of semi-persistent scheduling configuration on second carrier.

As described above. FIG. 8 is provided as an example. Other examples are possible according to some embodiments.

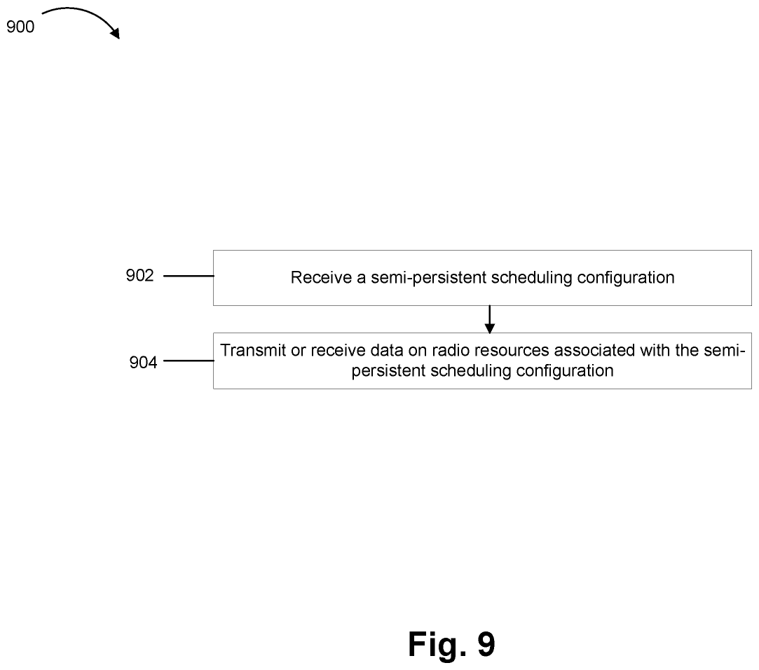

FIG. 9 illustrates an example flow diagram of a method 900, according to some embodiments. For example, FIG. 9 may illustrate example operations of a UE (e.g., apparatus 20 illustrated in, and described with respect to, FIG. 10b). Some of the operations illustrated in FIG. 9 may be similar to some operations shown in, and described with respect to, FIGS. 1-7.

In an embodiment, the method 900 may include, at 902, receiving a semi-persistent scheduling configuration, e.g., in a manner similar to that at 102 of FIG. 1. The semi-persistent configuration may include an indication of at least a number of transport blocks per semi-persistent scheduling cycle, e.g., in a manner similar to that at 102-a of FIG. 1. The number of transport blocks may be more than one. The method 900 may include, at 904, transmitting or receiving data on radio resources associated with the semi-persistent scheduling configuration.

The method illustrated in FIG. 9 may include one or more additional aspects described below or elsewhere herein. In some embodiments, the method 900 may include receiving signaling to activate the semi-persistent scheduling configuration, e.g., in a manner similar to that at 104 of FIG. 1. In some embodiments. the semi-persistent scheduling configuration may include an indication of a periodicity of a semi-persistent scheduling cycle. In some embodiments, the indication may include a number of radio frames for which a semi-persistent scheduling pattern is repeated. In some embodiments, the periodicity of the semi-persistent scheduling cycle may include a time interval between two resource allocations that is not constant. In some embodiments, the method 900 may further include receiving a dynamic semi-persistent scheduling configuration for updating the semi-persistent scheduling configuration, e.g., in a manner similar to that at 106 of FIG. 1. In some embodiments, the dynamic semi-persistent scheduling configuration may include one or more updated parameters for the semi-persistent scheduling configuration. In some embodiments, the one or more updated parameters may include at least a periodicity of the semi-persistent scheduling configuration. The dynamic semi-persistent scheduling configuration may be transmitted separately from the operations illustrated in FIG. 9. In some embodiments, the one or more updated parameters may include at least one of: one or more semi-persistent scheduling periodicities, one or more phases of one or more semi-persistent scheduling patterns, or one or more numbers of transport blocks per semi-persistent scheduling cycle. In some embodiments. the one or more conditions for controlling application of the one or more updated parameters may include one or more of: a change in signal quality conditions at the user equipment, a change in service after activation of the semi-persistent scheduling configuration, or a change in a size of a payload associated with the transport blocks after activation of the semi-persistent scheduling configuration.

In some embodiments. the configuration may further include an indication that the transport blocks may include contiguous resources in a time domain. In some embodiments. the configuration may further include an indication that the transport blocks may include non-contiguous resources in a time domain. In some embodiments, the configuration may further include an indication that the non-contiguous resources may be separated by different time offsets or constant time offsets. In some embodiments, the configuration may include hybrid automatic repeat request process identifiers for the transport blocks. In some embodiments, the hybrid automatic repeat request process identifiers may be determined based on at least one or more of: the number of transport blocks, a slot or symbol index of a first transport block in a current semi-persistent scheduling cycle, and a transport block of a semi-persistent scheduling cycle. In some embodiments. the semi-persistent scheduling configuration may further include an indication of at least whether multiple component carriers are to be used for the transport blocks.

As described above. FIG. 9 is provided as an example. Other examples are possible according to some embodiments.

FIG. 10a illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB). 5G Node B or access point, next generation Node B (NG-NB or gNB), and/or a WLAN access point, associated with a radio access network, such as a LTE network, 5G or NR. In some example embodiments, apparatus 10 may be an eNB in LTE or gNB in 5G.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 10a.

As illustrated in the example of FIG. 10a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 10a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM). static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IOT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, or the like.

According to certain embodiments, apparatus 10 may be controlled by memory 14 and processor 12 to perform the functions associated with any of the embodiments described herein, such as some operations illustrated in, or described with respect to. FIGS. 1-8. For instance, apparatus 10 may be controlled by memory 14 and processor 12 to perform the method of FIG. 8.

FIG. 10b illustrates an example of an apparatus 20 according to another embodiment. In an embodiment, apparatus 20 may be a node or clement in a communications network or associated with such a network, such as a UE, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IOT device, a watch or other wearable, a head-mounted display (HMD), a vehicle, a drone, a medical device and applications thereof (c.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IOT, Bluetooth, NFC, MulteFire, and/or any other radio access technologies. It should be noted that one of ordinary skill in the art would understand that apparatus 20 may include components or features not shown in FIG. 10b.

As illustrated in the example of FIG. 10b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 10b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IOT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry. As discussed above, according to some embodiments, apparatus 20 may be a UE, mobile device, mobile station, ME, IoT device and/or NB-IOT device, for example. According to certain embodiments, apparatus 20 may be controlled by memory 24 and processor 22 to perform the functions associated with any of the embodiments described herein, such as some operations illustrated in, or described with respect to, FIGS. 1-7 and 9. For instance, in one embodiment, apparatus 20 may be controlled by memory 24 and processor 22 to perform the method of FIG. 9.

In some embodiments, an apparatus (e.g., apparatus 10 and/or apparatus 20) may include means for performing a method or any of the variants discussed herein, e.g., a method described with reference to FIG. 8 or 9. Examples of the means may include one or more processors, memory, and/or computer program code for causing the performance of the operation.

Therefore, certain example embodiments provide several technological improvements, enhancements, and/or advantages over existing technological processes. For example, one benefit of some example embodiments is reduced signaling and/or reduced consumption of computing resources in association with SPS configurations. Accordingly, the use of some example embodiments results in improved functioning of communications networks and their nodes and, therefore constitute an improvement at least to the technological field of SPS configurations, among others.

Although certain embodiments are described with respect downlink SPS, certain embodiments may also be applied to semi-persistent resource allocation schemes in uplink, also known as configured grants (CG) in NR. For example, there may be two different ways for configuring and indicating the CG resource allocation, such as CG type 1, where the parameters, including resource allocation, are provided via RRC configuration (no dynamic activation via DCI used), and CG type 2, which may work similarly as the described DL SPS operation: some parameters may be provided via RRC configuration and the resource allocation may be provided in the activation DCI.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and may include program instructions to perform particular tasks.

A computer program product may include one or more computer-executable components which, when the program is run, are configured to carry out some example embodiments. The one or more computer-executable components may be at least one software code or portions of code. Modifications and configurations used for implementing functionality of an example embodiment may be performed as routine(s), which may be implemented as added or updated software routine(s). In one example, software routine(s) may be downloaded into the apparatus.

As an example, software or a computer program code or portions of code may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, such as a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein apply equally to both singular and plural implementations, regardless of whether singular or plural language is used in connection with describing certain embodiments. For example, an embodiment that describes operations of a single network node equally applies to embodiments that include multiple instances of the network node, and vice versa.

One having ordinary skill in the art will readily understand that the example embodiments as discussed above may be practiced with operations in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

AR Augmented Reality
CE Control Element
CG Cloud Gaming
DCI Downlink control information
eSPS Enhanced SPS
fps Frames per second
IE Information Element
MAC Medium access control
PDCCH Physical downlink control channel
PDSCH Physical downlink shared channel
RRC Radio resource control
SCS Subcarrier spacing
SPS Semi-persistent scheduling
TSC Time sensitive communication
UE User equipment
VR Virtual Reality
QoE Quality of experience
QOS Quality of service
XR Extended Reality

1. An apparatus, comprising:
at least one processor; and
at least one memory including computer program code,
wherein the at least one memory and the computer program code are configured to, with the at least one processor, cause the apparatus at least to:
transmit, to a user equipment, a semi-persistent scheduling configuration comprising an indication of at least:
a number of transport blocks per semi-persistent scheduling cycle, wherein the number of transport blocks is more than one.

2. The apparatus according to claim 1, wherein the semi-persistent scheduling configuration further comprises an indication of a periodicity or frequency of a semi-persistent scheduling cycle and a periodic time pattern indicating time instances where transport blocks associated with the semi-persistent scheduling configuration are scheduled.

3. The apparatus according to claim 2, wherein the periodicity of the semi-persistent scheduling cycle comprises a time interval between two resource allocations that is not constant.

4. The apparatus according to claim 1, wherein the at least one memory and the computer program code are configured to, with the at least one processor, further cause the apparatus at least to:
transmit, to the user equipment, a dynamic semi-persistent scheduling configuration for updating the semi-persistent scheduling configuration, wherein the dynamic semi-persistent scheduling configuration comprises one or more updated parameters for the semi-persistent scheduling configuration.

5. The apparatus according to claim 4, wherein the one or more updated parameters comprise at least one of:
one or more semi-persistent scheduling periodicities, one or more phases of one or more semi-persistent scheduling patterns, or one or more numbers of transport blocks per semi-persistent scheduling cycle.

6. The apparatus according to claim 4, wherein one or more conditions for controlling application of the one or more updated parameters comprise one or more of:
a change in signal quality conditions at the user equipment,
a change in service after activation of the semi-persistent scheduling configuration, or
a change in a size of a payload associated with the transport blocks after activation of the semi-persistent scheduling configuration.

7. The apparatus according to claim 1, wherein the configuration further comprises an indication that the transport blocks comprise contiguous resources in a time domain.

8-12. (canceled)

13. An apparatus, comprising:
at least one processor; and
at least one memory including computer program code,
wherein the at least one memory and the computer program code are configured to, with the at least one processor, cause the apparatus at least to:
receive a semi-persistent scheduling configuration comprising an indication of at least:
a number of transport blocks per semi-persistent scheduling cycle, wherein the number of transport blocks is more than one.

14. The apparatus according to claim 13, wherein the semi-persistent scheduling configuration further comprises an indication of a periodicity or frequency of a semi-persistent scheduling cycle and a periodic time pattern indicating time instances where transport blocks associated with the semi-persistent scheduling configuration are scheduled.

15. The apparatus according to claim 14, wherein the periodicity of the semi-persistent scheduling cycle comprises a time interval between two resource allocations that is not constant.

16. The apparatus according to claim 13, wherein the at least one memory and the computer program code are configured to, with the at least one processor, further cause the apparatus at least to:
receive a dynamic semi-persistent scheduling configuration for updating the semi-persistent scheduling configuration, wherein the dynamic semi-persistent scheduling configuration comprises one or more updated parameters for the semi-persistent scheduling configuration, wherein the one or more updated parameters comprise at least a periodicity of the semi-persistent scheduling configuration.

17. The apparatus according to claim 16, wherein the one or more updated parameters comprise at least one of:
one or more semi-persistent scheduling periodicities,
one or more phases of one or more semi-persistent scheduling patterns, or
one or more numbers of transport blocks per semi-persistent scheduling cycle.

18. The apparatus according to claim 16, wherein the one or more conditions for controlling application of the one or more updated parameters comprise one or more of:
a change in signal quality conditions at the apparatus,
a change in service after activation of the semi-persistent scheduling configuration, or
a change in a size of a payload associated with the transport blocks after activation of the semi-persistent scheduling configuration.

19. The apparatus according to claim 13, wherein the configuration further comprises an indication that the transport blocks comprise contiguous resources in a time domain.

20. The apparatus according to claim 13, wherein the configuration further comprises an indication that the transport blocks comprise non-contiguous resources in a time domain.

21. The apparatus according to claim 13, wherein the configuration further comprises an indication that the non-contiguous resources are separated by different time offsets or constant time offsets.

22. The apparatus according to claim 13, wherein the configuration comprises hybrid automatic repeat request process identifiers for the transport blocks.

23. The apparatus according to claim 22, wherein the hybrid automatic repeat request process identifiers are determined based on at least one or more of:
the number of transport blocks,
a slot or symbol index of a first transport block in a current semi-persistent scheduling cycle, and
a transport block of a semi-persistent scheduling cycle.

24. The apparatus according to claim 13, wherein the semi-persistent scheduling configuration further comprises an indication of at least whether multiple component carriers are to be used for the transport blocks.

25-36. (canceled)

37. A method, comprising:
receiving a semi-persistent scheduling configuration comprising an indication of at least:
a number of transport blocks per semi-persistent scheduling cycle, wherein the number of transport blocks is more than one.

38-51. (canceled)
